(19) United States
(12) Patent Application Publication
(10) Pub. No.: US 2019/0147496 A1
(43) Pub. Date: May 16, 2019

(54) SYSTEM AND METHOD FOR PROVIDING REAL-TIME TARGETED ADVERTISEMENTS

(71) Applicant: Christopher Faraguna, Newport, PA (US)

(72) Inventor: Christopher Faraguna, Newport, PA (US)

(21) Appl. No.: 16/101,593

(22) Filed: Aug. 13, 2018

Related U.S. Application Data
(63) Continuation-in-part of application No. 15/811,873, filed on Nov. 14, 2017.

(51) Int. Cl. G06Q 30/02; H04L 29/08; G06Q 50/00

(52) U.S. Cl. CPC G06Q 30/0271; G06Q 30/0255; G06Q 30/0267; G06Q 50/01; H04L 67/22; H04L 67/306; G06Q 30/0209

(57) ABSTRACT

A system for providing real-time targeted advertising based on one or more categorical identifiers, the system comprising a social networking platform requiring users to create user profiles, one or more computing platforms capable of storing a cookie, said cookie used to track a user's navigation on the social networking platform, an incentivized data collection technique comprising of a plurality of incentivized activities executed through the social networking platform, said incentivized activities for obtaining demographic information and interest information from users, means for assigning one or more first unique identifiers to a user based on the demographic and interest information obtained from said user, and a module operating on the social networking platform, said module for allowing advertisers to preassign to one or more ads one or more second unique identifiers applicable to the advertisers' targeted users, said module matching the one or more second unique identifiers of the ads to the one or more first categorical identifiers in real-time as the one or more first categorical identifiers are assigned to a user, said module immediately displaying said ads to the matched users.

### CROSS REFERENCE TO RELATED APPLICATIONS

This application is a continuation-in-part of application Ser. No. 15/811,873, filed on Nov. 14, 2017.

### BACKGROUND

### Field of the Invention

The present invention relates generally to systems and methods of providing real time targeted advertisements, and in particular, to a system and method of providing real time targeted advertisements on the internet using data collected through an incentivized data collection technique via a social media networking platform.

### Related Art

Targeted advertising is a form of advertising where ads are placed based on consumer demographics, interests, prior shopping history and/or behavior. Targeted advertising is well known and widely used by companies due to its tendency to produce high conversion rates.

Information used to target consumers is typically collected as a result of the consumers' activities across a variety of websites. This is accomplished by storing a cookie on a user's computer, where the cookie tracks the user's navigation to various websites across the internet. This navigation activity is then provided to advertisers for targeted marketing efforts.

The present invention is directed to a system and method of targeting consumers in real-time based on consumer information collected across one social networking platform, wherein such information is collected through an incentivized data collection technique. The incentive provided from the incentivized data collection technique may be in the form of a redeemable points-based systems where a user on the social networking platform is incentivized to fully complete their user profile, respond to surveys and questionnaires, participate in games and interact with other users in order to accumulate points which are redeemable for goods and services. The user may also be incentivized by winning trips or being entered into giveaways and sweepstakes contests.

### SUMMARY OF THE INVENTION

It is to be understood that the phraseology and terminology employed herein are for the purpose of the description and should not be regarded as limiting.

The present invention is directed to a system and method for providing real-time targeted advertising, the system comprising of a social networking platform requiring users to create user profiles, the user profiles comprising of demographic information and interest information. One or more computing platforms capable of storing a cookie, said cookie used to track a user's navigation on the social networking platform, said social networking platform accessed by the user through a browser executed on the one or more computing platforms. A plurality of incentivized activities executed on the social networking platform, said incentivized activities for obtaining demographic information and interest information from users. The system further comprising of means for assigning one or more first categorical identifiers to a user based on the demographic information and interest information obtained from said user through said cookie and said incentivized activities collectively. The social networking platform further comprising of a module, said module for allowing advertisers to preselect and assign one or more second categorical identifiers to one or more ads applicable to the advertisers' targeted users. Said module matching the one or more second categorical identifiers of the one or more ads to the one or more first categorical identifiers assigned to a user, at the moment of assignment. Said module immediately thereafter displaying ads to the advertisers' targeted users. These and other features of the present invention will become readily apparent upon further review of the specification and drawings.

### BRIEF DESCRIPTION OF THE DRAWINGS

Embodiments of the present invention will be described by way of example only, and not limitation, with reference to the accompanying drawings in which:

FIG. 1 is a block diagram illustrating a system for providing real-time targeted advertising according to an embodiment of the present invention;

FIG. 2 is a flow chart illustrating a method for providing real-time targeted advertising according to an embodiment of the present invention;

FIG. 3 is an example of a user profile on a social networking platform according to an embodiment of the present invention;

FIG. 4 is an example of a user interface screen of a social networking platform according to an embodiment of the present invention;

FIG. 5 is an example of a user interface screen of a social networking platform according to an embodiment of the present invention; and

FIG. 6 is an example of a user screen of a social networking platform according to an embodiment of the present invention.

### DETAILED DESCRIPTION

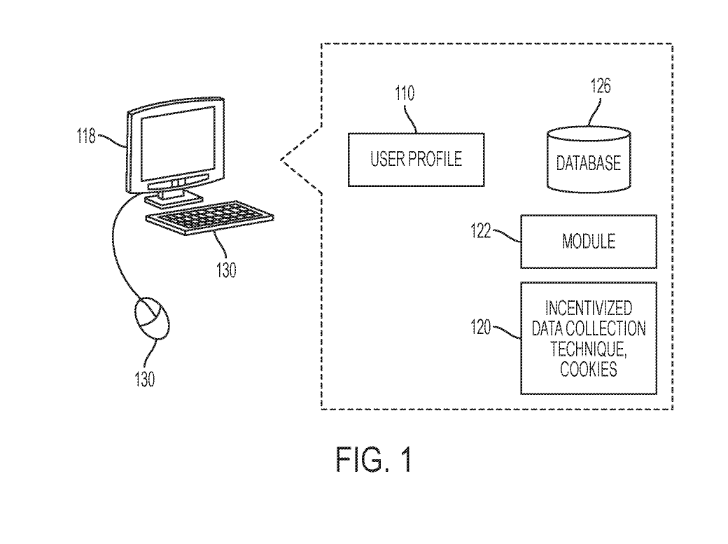

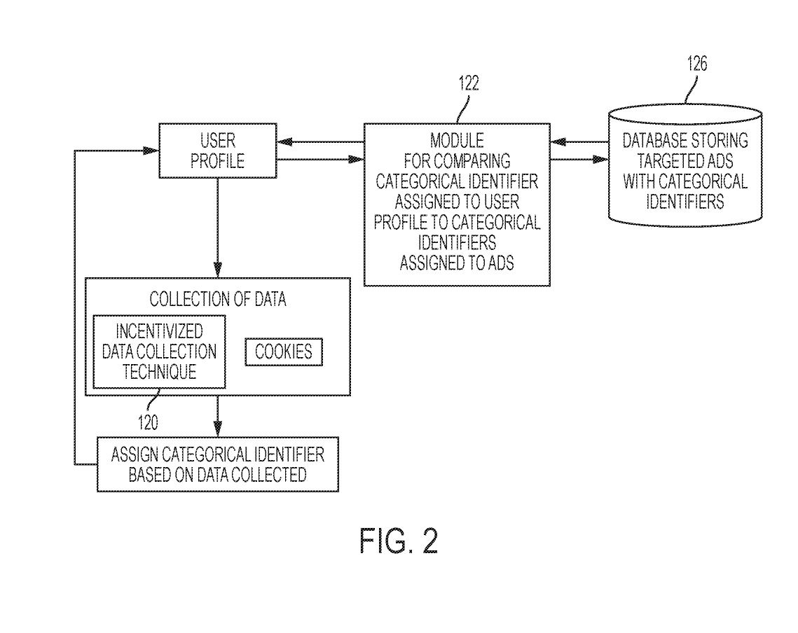

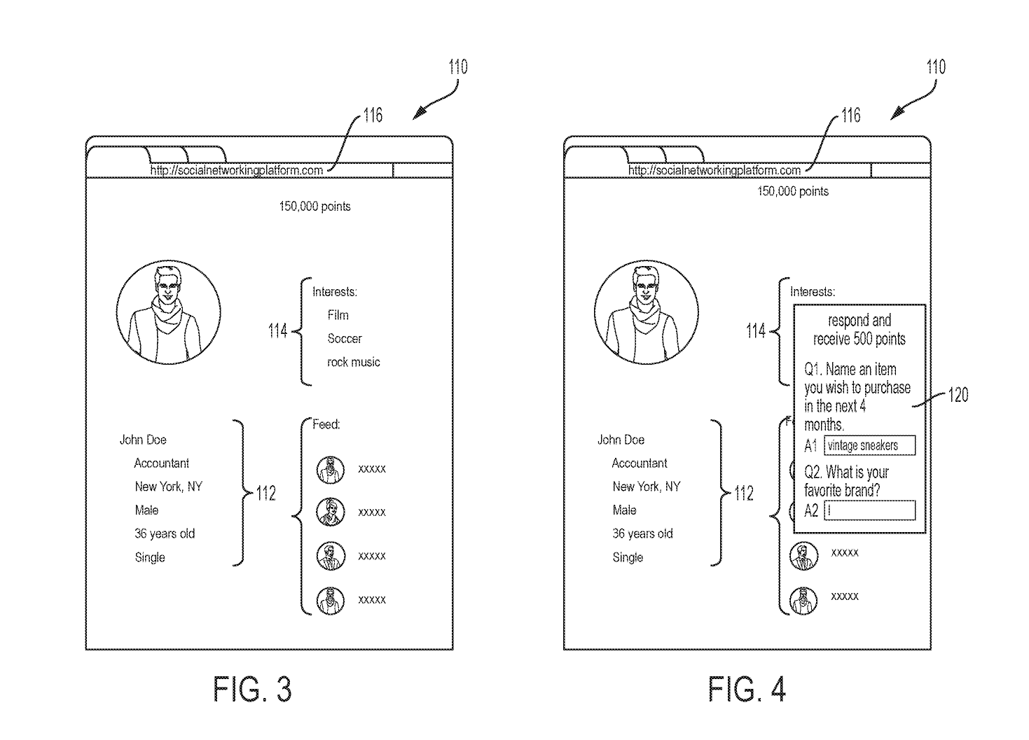

Referring now to the figures, where similar reference characters denote similar elements throughout the figures, FIGS. 1 to 6 illustrating a system for providing targeted advertising. The system comprising of a social networking platform requiring users to create user profiles 110, said user profiles 110 comprising of demographic information 112 and interest information 114. Demographic information 112 may include, but is not limited to, a user's name, email address, location, age, birth date, gender, race, and sexual orientation. Interest information 114 may include hobbies, favorite music and/or movies, brand interests, and favorite foods. The social networking platform is accessed by the user through a browser 116 executed on a computing platform 118. The computing platform 118 is capable of storing a cookie, where the cookie is used to track a user's navigation on the social networking platform. The demographic information 112 and the interest information 114 is input by a user through an input/output device 130 when they create a user profile, and from time to time thereafter. However, some information, which may include interest information, may be obtained through the user's activity on the social networking platform through the use of cookies.

In an embodiment of the present invention, information is collected from users through an incentivized data collection technique 120. The incentive provided to users through the incentivized data collection technique 120 comprising of a redeemable points reward system where users accumulate points based on their participation in various activities on the social networking platform. Such activities may include, but are not limited to questionnaires, surveys, games, interactions with other users, and fully completing user profiles 110. The user may use the points accumulated to purchase and to obtain discounts on goods and services from various companies.

In an embodiment of the present invention an example of an incentivized data collection technique in the form of a game comprises of a treasure hunt using geocaching to locate coupons and sales discounts. The treasure hunt is offered through the social networking platform, where the platform is accessed through a mobile application executed on a mobile device. A user allows the mobile application to track their location when the mobile application is in use as well as when it is running in the background of the mobile device. When the user approaches a location where coupons, sales discounts, giveaways, and the like are within the user's proximity, a message is sent to that user through the mobile application with a clue to locate such sales deals. The user may be required to find a plurality of locations in order to access a sales deal. The user may be required to respond to questions, puzzles and/or surveys in order to access a clue. By keeping the location tracking on the mobile device in operation at all times, the user's location data is being collected by the mobile application. The user is incentivized to allow location tracking by the mobile application at all times, by the opportunity to locate sales deals. The treasure hunt may be used to drive users through brick and mortar stores. The user may be required to locate and scan a specific item in the store in order to receive a clue for the next location or item to be found. The user may also be incentivized to make purchases while in the store through the offering of affiliate deals sent via the mobile application in real-time for goods within the user's vicinity. In instances where it may be difficult to identify a specific location inside of a large building, one or more wireless frequency transmitters may be used. By way of example only, a user may be required to locate and scan a specific item inside of a shopping mall. In order for the user to receive alerts that they have located the correct item and/or that they are close to where that item is located, a wireless frequency transmitter may be placed at the item's location. When the user approaches the wireless frequency transmitter, the wireless frequency transmitter sends data to the mobile application operating on the user's mobile device and the mobile application then produces an audio or text notification to the user. The frequency transmitter being able to send a signal at a maximum of 30 feet from a user's mobile device. One example of such a transmitter is a Bluetooth® transmitter.

In an embodiment of the present invention, the user's may register to become treasure hunt administrators where they can create their own clues and/or trivia questions. The treasure hunt administrator places one or more wireless frequency transmitters at the locations at which rewards and/or clues may be found. When the user approaches the wireless frequency transmitter, the wireless frequency transmitter sends data to the mobile application operating on the user's mobile device and the mobile application then produces an audio or text notification to the user.

Additional examples of incentivized data collection techniques 120 in the form of games may comprise of lotteries, virtual scratch off contests, esports competitions, and sports prediction contest. In an incentivized data collection technique 120 in the form of an esports competition, users may be allowed to compete against their friends or against strangers with the winner receiving money and rewards in exchange for their demographic information 112 and interest information 114. In an incentivized data collection technique 120 in the form of an electronic sports prediction contest, users can make predictions on the results of real-life sport teams by guessing the winner of a game or the number of points by which a specific team may win or that a specific player may score. The winner of the contest may receive cash, points, coupons or other rewards. Data is collected by virtue of the users entering the contest.

An incentivized activity in the form of a survey or questionnaire may use a natural language user interface to allow the user to respond to questions via text or verbally, the user's verbal responses are converted to text and saved to a user's profile.

In a preferred embodiment of the present invention the incentivized data collection technique 120 earns a user a combination of point accumulation and rewards for their participation in various activities across the social networking platform. Rewards may include travel, tangible goods, entrance into giveaways and sweepstakes contests, and coupons.

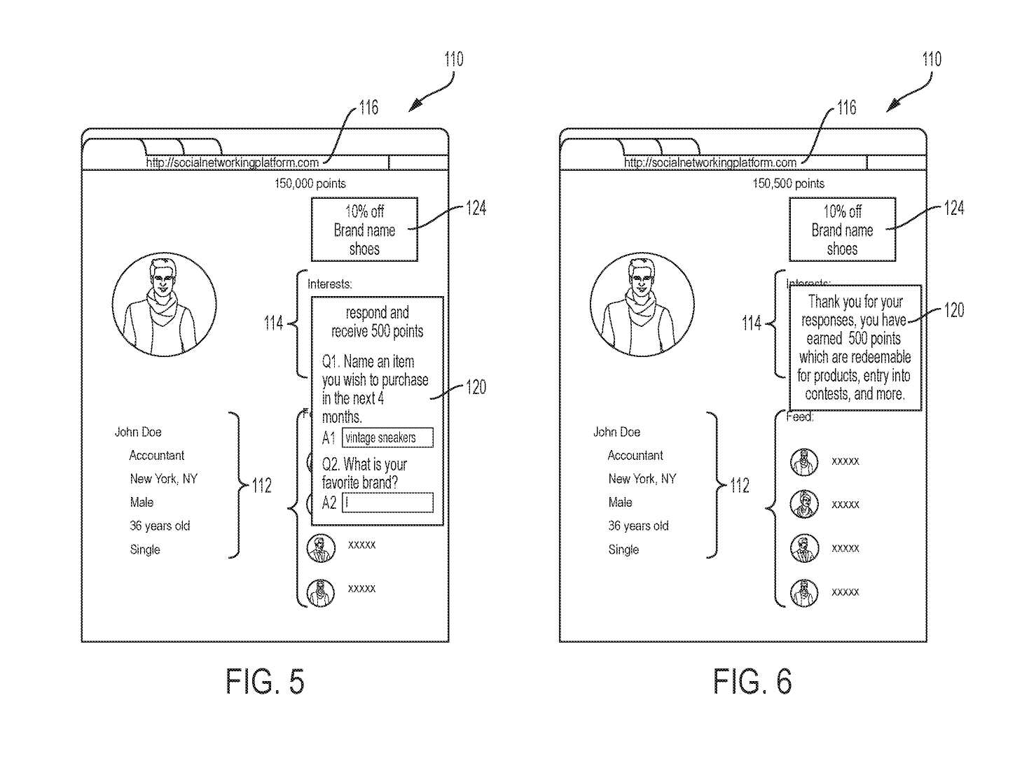

Based on the behavioral data collected by the cookies, and the demographic data 112 and the interest data 114 collected through the incentivized data collection technique 120, the user is continuously assigned and re-assigned one or more first categorical identifiers based on such data, as the data is being collected. A module 122 operates on the social networking platform for allowing advertisers to preselect one or more second categorical identifiers applicable to the advertisers' targeted users. The module 122 matching the one or more second categorical identifiers selected by the advertisers to the one or more first categorical identifiers in real-time as the one or more first categorical identifiers are assigned to a user. The module immediately displaying ads 124 to the advertisers' targeted users based on said matches. For example, in FIGS. 5 and 6, the user responds to an incentivized data collection technique 120 in the form of a questionnaire. As the user is completing the questionnaire, one or more first categorical identifiers are being assigned and/or reassigned to the user. When one or more first categorical identifiers are assigned to a user which match the one or more second categorical identifiers of an ad 124 stored in the social networking platform's database 126, that ad 124 is displayed to the user in real-time as the user continues to complete the questionnaire. In one embodiment, the ads 124 are placed by an advertiser at no cost to the advertiser. Where an ad 124 results in a purchase by a user, the social networking platform obtains a commission from said purchase.

Categorical identifiers are tags assigned to a user's profile based on demographics and interests. For example, age ranges, location, gender, their preference in genre of music, or a combination thereof.

Interest data 114 collected through the incentivized data collection technique 120, may include a user's brand interests. A user's brand interests are assigned as first categorical identifiers allowing advertisers to display products from such brands on a user's profile by means of the module 122 matching these first categorial identifiers with the one or more second categorical identifiers of the advertisers. Interest data may also be collected through the use of an artificial intelligence bot which matches a user's interests to relevant coupons and giveaways.

What is claimed is:

1. A system for providing real-time targeted advertising based on one or more categorical identifiers, the system comprising:
a. a social networking platform requiring a user to create a user profile, said user profile comprising of demographic information and interest information;
b. one or more computing platforms capable of storing a cookie, said cookie used to track the user's navigation on the social networking platform, said social networking platform accessed by the user through a browser executed on the one or more computing platforms;
c. an incentivized data collection technique comprising of a plurality of incentivized activities executed through the social networking platform, said incentivized activities for obtaining demographic information and interest information from the user;
d. means for assigning one or more first unique identifiers to the user's profile based on the demographic and interest information obtained from said user through said cookie and said incentivized activities; and
e. a module operating on the social networking platform, said module for allowing advertisers to preassign to one or more ads one or more second unique identifiers applicable to the advertisers' targeted users, said module matching the one or more second unique identifiers of the ads to the one or more first categorical identifiers in real-time as the one or more first categorical identifiers are assigned to the users, said module immediately displaying said ads to the matched users.

2. The system of claim 1, wherein said incentivized activities include at least one member selected from the group consisting of: questionnaires, surveys, games, interactions with other users, and completely filling out a user profile.

3. The system of claim 1, wherein the incentivized data collection technique consists of a treasure hunt game, the system further comprising of a wireless frequency transmitter and a mobile device, said wireless frequency transmitter for sending a signal to the mobile device when the mobile device is within 0 feet to 30 feet from the wireless frequency transmitter.

4. A computer implemented real-time targeted advertising system comprising:
a. an incentivized data collection technique comprising of a plurality of incentivized activities executed through a social networking platform, said incentivized activities for obtaining demographic information and interest information from a user;
b. a database of ads stored on the network server of the social networking platform, wherein said ads comprise of one or more preassigned second categorical identifiers;
c. means for assigning one or more first categorical identifiers to a user based on the user's ability on the social media platform and data collected through the incentivized activities;
d. a module operating on the social networking platform, the module matching the one or more second categorical identifiers of the ads to the one or more first categorical identifiers assigned to the user; and
e. One or more ads displayed to the user on the social networking platform.

5. A method for providing targeted advertising to a user based on categorical identifiers, the method comprising:
a. providing the social networking platform of claim 1, said social networking platform accessed through a browser executed on a computing platform, wherein said computing platform is capable of storing a cookie, said cookie stored on said computing platform when a user accesses the social networking platform through a browser on said computing platform;
b. providing a database of ads stored on the network server of the social networking platform, wherein said ads comprise of one or more preassigned second categorical identifiers;
c. assigning one or more first categorical identifiers to the user of the social networking platform based on demographic information and interest information acquired through an incentivized data collection technique, said incentivized data collection technique comprising of a plurality of incentivized activities wherein said users are provided incentives to perform activities on the social networking platform;
d. matching in real-time, through a module operating on the social networking platform, the one or more second categorical identifiers of the ads to the one or more first categorical identifiers assigned to the user; and
e. displaying an ad based on said matching.

6. The method of claim 5, wherein said incentives are redeemable points.

7. The method of claim 5, wherein said incentives are rewards.

8. The method of claim 7, wherein said rewards are selected from the group consisting of: coupons, travel, tangible goods, redeemable points, entrance into giveaway contests, and entrance into sweepstakes contests.
